(19) United States
(12) Patent Application Publication
(10) Pub. No.: US 2025/0187574 A1
(43) Pub. Date: Jun. 12, 2025

(54) BRAKING CONTROL DEVICE FOR VEHICLES

(71) Applicant: ADVICS CO., LTD., Kariya-shi, Aichi-ken (JP)

(72) Inventors: Keisuke TANAKA, Kariya-shi, Aichi-ken (JP); Takashi EBINE, Kariya-shi, Aichi-ken (JP); Takuya NAKANO, Kariya-shi, Aichi-ken (JP)

(73) Assignee: ADVICS CO., LTD., Kariya-shi, Aichi-ken (JP)

(21) Appl. No.: 18/840,301

(22) PCT Filed: Mar. 10, 2023
(86) PCT No.: PCT/JP2023/009435

§ 371 Date: Aug. 21, 2024

(30) Foreign Application Priority Data
Mar. 10, 2022 (JP) 2022-036962

(51) Int. Cl. B60T 13/18; B60T 8/1755; B60T 13/68

(52) U.S. Cl. CPC B60T 13/18; B60T 8/1755; B60T 13/68

(57) ABSTRACT

A braking control device for vehicles includes an upper braking unit that electrically outputs a supply pressure according to a braking request amount; and a lower braking unit that is disposed between the upper braking unit and a plurality of wheel cylinders, adjusts the supply pressure with respect to each of the plurality of wheel cylinders, and outputs a wheel pressure. When the lower braking unit executes the sideslip prevention control, the upper braking unit increases the supply pressure to a demand pressure necessary for executing the sideslip prevention control.

### TECHNICAL FIELD

The present disclosure relates to a braking control device for vehicles.

### BACKGROUND ART

Patent Literature 1 describes that “disposing a yaw moment control device that generates a brake fluid pressure for individually operating a wheel cylinder by a second electric motor in a liquid path between the wheel cylinder and a slave cylinder that generates a brake fluid pressure by a first electric motor driven according to an operation amount of a brake pedal by a driver, and temporarily operating the slave cylinder at the start of the operation of the yaw moment control device” in order to enhance initial responsiveness of brake fluid pressure generation in a control (referred to as “sideslip prevention control”) for stabilizing a vehicle behavior by controlling a yaw moment of the vehicle. The device of Patent Literature 1 includes two braking units: a unit (referred to as an “upper braking unit”) that uses a first electric motor (also referred to as an “upper electric motor”) as a power source; and a unit (referred to as a “lower braking unit”) that uses a second electric motor (also referred to as a “lower electric motor”) as a power source. In the device of Patent Literature 1, the hydraulic pressure (referred to as “wheel pressure”) of the wheel cylinder is increased by both the upper braking unit and the lower braking unit at the start of the sideslip prevention control so as to improve the boosting responsiveness of the wheel pressure.

In the sideslip prevention control, the braking force, the yaw moment, and the like required for stabilizing the vehicle behavior depend on the specifications of the vehicle. Therefore, the output of the lower braking unit that executes the sideslip prevention control needs to be set for each vehicle. In the braking control device, the lower braking unit is desired to be made common among various vehicles.

### CITATIONS LIST

### Patent Literature

Patent Literature 1: JP 2009-227023 A

### SUMMARY

### Technical Problems

An object of the present disclosure is to provide a braking control device for vehicles including two braking units, in which a lower braking unit that executes sideslip prevention control can be made common.

### Solutions to Problems

A braking control device (SC) for vehicles according to the present disclosure includes: an upper braking unit (SA) that electrically outputs a supply pressure (Pm) according to a braking request amount (Bs); and a lower braking unit (SB) that is disposed between the upper braking unit (SA) and a plurality of wheel cylinders (CW), individually adjusts the supply pressure (Pm) with respect to each of the plurality of wheel cylinders (CW), and outputs a wheel pressure (Pw). When the lower braking unit (SB) executes the sideslip prevention control, the upper braking unit (SA) increases the supply pressure (Pm) to a demand pressure (Pe) necessary for executing the sideslip prevention control. Here, the demand pressure (Pe) is determined based on a maximum value (Max [Po]) of necessary pressures (Po) required for each of the plurality of wheel cylinders (CW).

According to the above configuration, the hydraulic pressure Pe (demand pressure) required for the sideslip prevention control is supplied by the upper braking unit SA. Therefore, in the lower braking unit SB, the hydraulic pressure Pm (supply pressure) supplied from the upper braking unit SA only needs to be individually adjusted in each wheel cylinder CW. Since the lower braking unit SB is not required to output a high voltage and high response output, the lower braking unit SB can cope with vehicles having different specifications, and the lower braking unit SB is made common.

In the braking control device (SC) for a vehicle according to the disclosure, when the upper braking unit (SA) cannot increase the supply pressure (Pm) to the demand pressure (Pe), the lower braking unit (SB) increases the wheel pressure (Pw) by a deviation (hP) between the supply pressure (Pm) and the demand pressure (Pe). According to the above configuration, since the demand pressure Pe is achieved even if the output of the upper braking unit SA decreases, the performance of the sideslip prevention control is secured.

### BRIEF DESCRIPTION OF DRAWINGS

FIG. 1 is a schematic view for explaining an overall configuration of a vehicle JV equipped with a braking control device SC according to the present disclosure.

FIG. 2 is a schematic diagram for explaining a configuration example of an upper braking unit SA.

FIG. 3 is a schematic diagram for explaining a configuration example of a lower braking unit SB.

FIG. 4 is a block diagram for explaining pressure adjusting control in the upper braking unit SA.

FIG. 5 is a flowchart for explaining complementary control in the lower braking unit SB.

### DESCRIPTION OF EMBODIMENT

### <Symbols of Configuring Members, Etc., and Subscripts at the End of the Symbols>

In the following description, configuring members, calculation processes, signals, characteristics, and values having the same symbol such as “CW” have the same functions. The subscripts “f” and “r” attached to the end of the symbol related to each wheel are comprehensive symbols indicating which system of the front and rear wheels the subscripts relate to. For example, the wheel cylinders CW provided on the respective wheels are described as “front wheel cylinder CWf” and “rear wheel cylinder CWr”. Furthermore, the subscripts “f” and “r” at the end of the symbols can be omitted. When the subscripts “f” and “r” are omitted, each symbol represents a generic name. For example, “CW” is a generic term for wheel cylinders provided on front and rear wheels of a vehicle.

In the fluid path from a master cylinder CM to a wheel cylinder CW, the side close to the master cylinder CM (the side far from the wheel cylinder CW) is referred to as an “upper portion”, and the side close to the wheel cylinder CW (the side far from the master cylinder CM) is referred to as a “lower portion”. In addition, in the circulation flows KN and KL of the braking fluid BF, the side close to a discharge portion of fluid pumps QA and QB (the side away from a suction portion) is referred to as “upstream side”, and the side close to a suction portion of the fluid pumps QA and QB (the side away from the discharge portion) is referred to as “downstream side”.

An upper actuator YA (also referred to as “upper fluid unit”) of the upper braking unit SA, a lower actuator YB (also referred to as “lower fluid unit”) of the lower braking unit SB, and the wheel cylinder CW are connected by a fluid path (communication path HS). Furthermore, in the upper and lower actuators YA and YB, various components (UA etc.) are connected by a fluid path. Here, the “fluid path” is a path for moving the braking fluid BF, and corresponds to a pipe, a flow path in an actuator, a hose, and the like. In the following description, a communication path HS, a reflux path HK, a return path HL, a reservoir path HR, an input path HN, a servo path HV, a pressure reducing path HG, and the like are fluid paths.

<Vehicle JV Equipped with Braking Control Device SC>

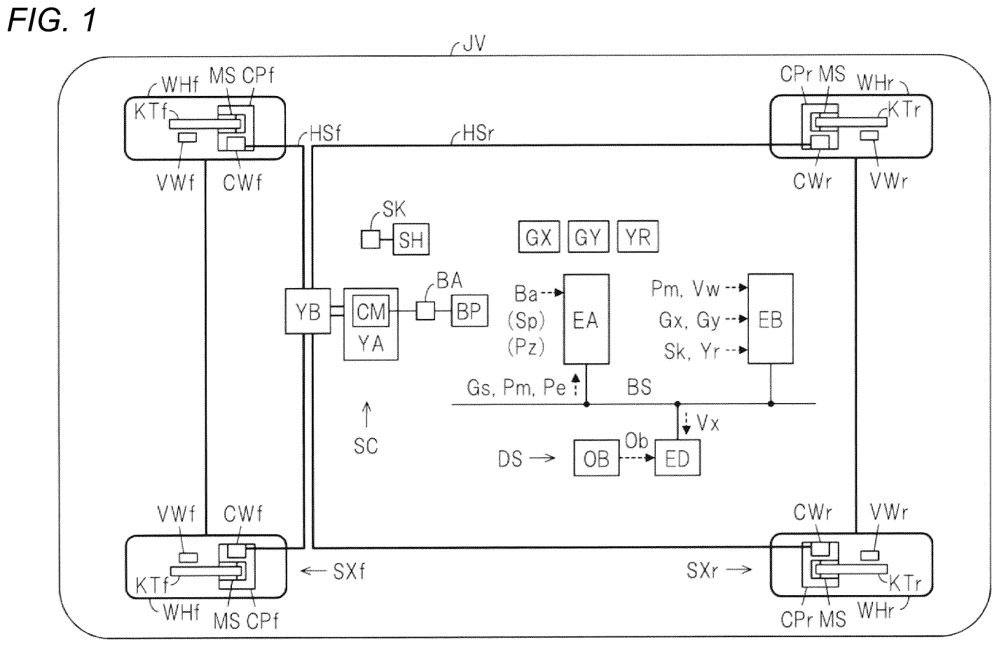

An overall configuration of a vehicle JV equipped with a braking control device SC according to the present disclosure will be described with reference to a schematic view of FIG. 1. The vehicle JV includes a driving assistance device DS such that control (referred to as “automatic braking control”) for automatically decelerating and stopping the vehicle via the braking control device SC is executed on behalf of or by assisting the driver. The driving assistance device DS includes a distance sensor OB and a control unit ED (also referred to as a “driving assistance controller”) for the driving assistance device. The distance sensor OB detects a distance Ob (relative distance) between an object (other vehicle, fixed object, person, bicycle, stop line, sign, signal, etc.) present in front of the own vehicle JV, and
the own vehicle JV and inputs the distance Ob to the driving assistance controller ED. In the driving assistance controller ED, a required deceleration Gs for automatically stopping the vehicle JV is calculated based on the relative distance Ob. The required deceleration Gs is a target value of the vehicle deceleration for executing the automatic braking control. The required deceleration Gs is output to the communication bus BS.

The vehicle JV includes front wheel and rear wheel braking devices SXf and SXr (=SX). The braking device SX includes a brake caliper CP, a friction member MS (e.g., a brake pad), and a rotating member KT (e.g., a brake disc). The brake caliper CP is provided with the wheel cylinder CW. The friction member MS is pressed against the rotating member KT fixed to each wheel WH by the hydraulic pressure Pw (referred to as “wheel pressure”) in the wheel cylinder CW. As a result, a friction braking force Fm is generated on the wheel WH. The “friction braking force Fm” is a braking force generated by the wheel pressure Pw.

The vehicle JV includes a braking operation member BP and a steering operation member SH. The braking operation member BP (e.g., a brake pedal) is a member operated by the driver to decelerate the vehicle JV. The steering operation member SH (e.g., the steering wheel) is a member operated by the driver to turn the vehicle JV.

The vehicle JV includes various sensors (BA etc.) listed below. Detection signals (Ba etc.) of these sensors are input to the controllers EA and EB and used for various controls.
A braking operation amount sensor BA that detects an operation amount Ba (referred to as a “braking operation amount”) of the braking operation member BP is provided. For example, an operation displacement sensor SP that detects the operation displacement Sp of the braking operation member BP is provided as the braking operation amount sensor BA. In addition, a simulator pressure sensor PZ that detects the hydraulic pressure Pz (referred to as “simulator pressure”) of the stroke simulator SS is adopted. In the braking control device SC, the braking operation amount Ba is a generic name of a signal representing a braking intention of the driver, and the braking operation amount sensor BA is a generic name of a sensor that detects the braking operation amount Ba. The braking operation amount Ba is input to the upper controller EA.
A wheel speed sensor VW that detects a rotational speed (wheel speed) Vw of the wheel WH is provided. The wheel speed Vw is input to the lower controller EB. The lower controller EB calculates the vehicle body speed Vx based on the wheel speed Vw. Furthermore, in the lower controller EB, anti-lock brake control for preventing locking of the wheels WH and traction control for preventing idling of the driving wheels WH are executed based on the wheel speed Vw and the vehicle body speed Vx.
A steering operation amount sensor SK that detects an operation amount Sk (a steering operation amount, for example, a steering angle) of the steering operation member SH is provided. The vehicle JV (In particular, the vehicle body) is provided with a yaw rate sensor YR that detects the yaw rate Yr, a longitudinal acceleration sensor GX that detects the longitudinal acceleration Gx, and a lateral acceleration sensor GY that detects the lateral acceleration Gy. These sensor signals are input to the lower controller EB. Then, in the lower controller EB, a sideslip prevention control (electronic stability control (ESC)) for suppressing oversteering and understeering and stabilizing yawing behavior of the vehicle JV is executed.

The vehicle JV includes a braking control device SC. In the braking control device SC, a front-rear type (also referred to as “type II”) is adopted as a two-system braking system. The actual wheel pressure Pw is adjusted by the braking control device SC.

The braking control device SC includes two braking units SA and SB. The upper braking unit SA is configured by an upper actuator YA (upper fluid unit) and an upper controller EA (upper control unit). The upper actuator YA is controlled by the upper controller EA. The lower braking unit SB is disposed between the upper braking unit SA and the wheel cylinder CW. The lower braking unit SB is configured by a lower actuator YB (lower fluid unit) and a lower controller EB (lower control unit). The lower actuator YB is controlled by the lower controller EB.

The upper braking unit SA (in particular, the upper controller EA), the lower braking unit SB (in particular, the lower controller EB), and the driving assistance device DS (in particular, the driving assistance controller ED) are connected to the communication bus BS. The “communication bus BS” has a network structure in which a plurality of controllers (control units) are suspended from a communication line. Signal transmission is carried out among the plurality of controllers (EA, EB, ED etc.) by the communication bus BS. That is, the plurality of controllers can transmit signals (detection value, calculation value, control flag, etc.) to the communication bus BS and receive signals from the communication bus BS.

### <Upper Braking Unit SA>

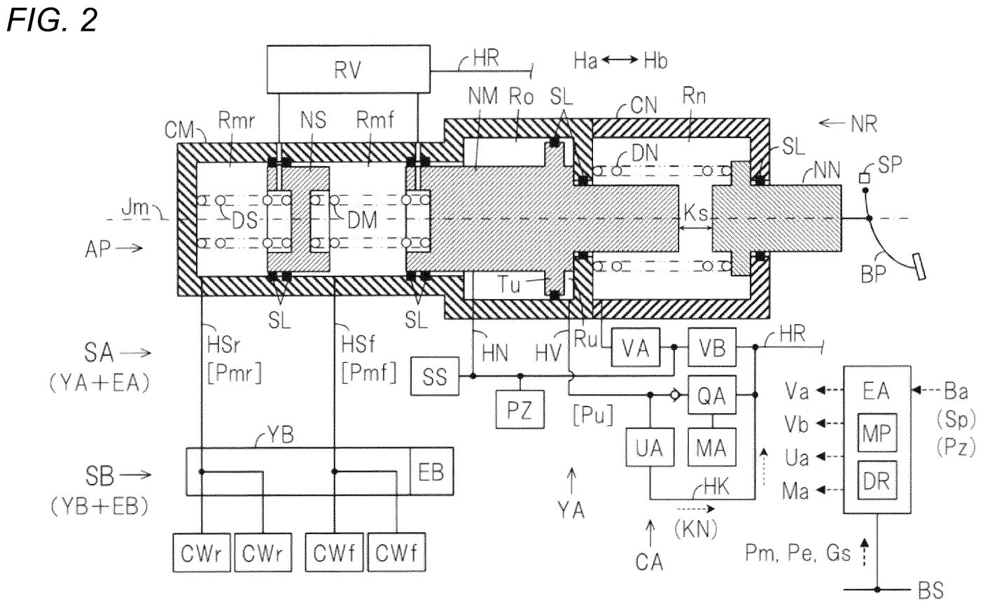

A configuration example of the upper braking unit SA will be described with reference to the schematic diagram of FIG. 2. The upper braking unit SA generates the supply pressure Pm in accordance with the operation of the braking operation member BP (brake pedal). The supply pressure Pm is eventually supplied to the wheel cylinder CW via the communication path HS (fluid path) and the lower braking unit SB. The upper braking unit SA is configured by the upper actuator YA and the upper controller EA.

### <<Upper Actuator YA>>

The upper actuator YA is configured by an apply unit AP, a pressure adjustment unit CA, and an input unit NR.

### [Apply Unit AP]

The supply pressure Pm is output from the apply unit AP according to the operation of the braking operation member BP. The apply unit AP is configured by a tandem type master cylinder CM, and primary and secondary master pistons NM and NS.

The primary and secondary master pistons NM and NS are inserted into the tandem type master cylinder CM. The inside of the master cylinder CM is divided into four hydraulic pressure chambers Rmf, Rmr, Ru, and Ro by the two master pistons NM and NS. The front wheel and rear wheel master chambers Rmf and Rmr (=Rm) are divided by the one-side bottom portion of the master cylinder CM and the master pistons NM and NS. Furthermore, the inside of the master cylinder CM is partitioned into a servo chamber Ru and a reaction force chamber Ro by a flange portion Tu of the master piston NM. The master chamber Rm and the servo chamber Ru are disposed so as to face each other with the flange portion Tu in between. These hydraulic pressure chambers Rmf, Rmr, Ru, and Ro are sealed by the seal member SL. Note that a pressure receiving area rm of the master chamber Rm is equal to a pressure receiving area ru of the servo chamber Ru.

At the time of non-braking, the master pistons NM and NS are at the most retracted positions (i.e., the position where the volume of the master chamber Rm is maximized). In this state, the master chamber Rm of the master cylinder CM communicates with the master reservoir RV. The braking fluid BF is stored inside the master reservoir RV (also referred to as “atmospheric pressure reservoir”). When the braking operation member BP is operated, the master pistons NM and NS are moved in the forward direction Ha (direction in which the volume of the master chamber Rm decreases). Communication between the master chamber Rm and the master reservoir RV is cut off by this movement. When the master pistons NM and NS are further moved in the forward direction Ha, the front wheel and rear wheel supply pressures Pmf and Pmr (=Pm) are increased from “0 (atmospheric pressure)”. As a result, the braking fluid BF pressurized to the supply pressure Pm is output (pressure-fed) from the master chamber Rm of the master cylinder CM. Since the supply pressure Pm is the hydraulic pressure of the master chamber Rm, it is also called “master pressure”.

### [Pressure Adjustment Unit CA]

The servo pressure Pu is supplied to the servo chamber Ru of the apply unit AP by the pressure adjustment unit CA. The pressure adjustment unit CA includes an upper electric motor MA, an upper fluid pump QA, and a pressure adjusting valve UA.

The upper electric motor MA (also simply referred to as an “electric motor”) drives the upper fluid pump QA (also simply referred to as a “fluid pump”). In the fluid pump QA, the suction portion and the discharge portion are connected by a reflux path HK (fluid path). The suction portion of the fluid pump QA is also connected to the master reservoir RV via the reservoir path HR. The discharge portion of the fluid pump QA is provided with a check valve.

The reflux path HK is provided with the normally-open pressure adjusting valve UA. The pressure adjusting valve UA is a linear type solenoid valve whose valve opening amount is continuously controlled based on an energized state (e.g., the supply current Ia). Since the pressure adjusting valve UA adjusts a hydraulic pressure difference (differential pressure) between the upstream side and the downstream side, it is also referred to as a “differential pressure valve”.

When the electric motor MA is driven and the braking fluid BF is discharged from the fluid pump QA, a circulation flow KN (indicated by a broken line arrow, also referred to as “upper circulation flow”) of the braking fluid BF is generated in the reflux path HK. When the pressure adjusting valve UA is in the fully opened state (since the pressure adjusting valve UA is a normally-open type, at the time of non-energization), the hydraulic pressure Pu (referred to as “servo pressure”) between the discharge portion of the fluid pump QA and the pressure adjusting valve UA is “0 (atmospheric pressure)” in the reflux path HK. When the energization amount Ia (supply current) to the pressure adjusting valve UA is increased, the circulation flow KN (flow of the braking fluid BF circulating in the reflux path HK) is throttled by the pressure adjusting valve UA. In other words, the flow path of the reflux path HK is narrowed by the pressure adjusting valve UA, and the orifice effect by the pressure adjusting valve UA is exerted. As a result, the hydraulic pressure Pu on the upstream side of the pressure adjusting valve UA is increased from “0”. That is, in the circulation flow KN, a hydraulic pressure difference (differential pressure) between the hydraulic pressure Pu (servo pressure) on the upstream side and the hydraulic pressure (atmospheric pressure) on the downstream side is generated with respect to the pressure adjusting valve UA. The differential pressure is adjusted by the supply current Ia to the pressure adjusting valve UA.

The reflux path HK is connected to the servo chamber Ru via the servo path HV (fluid path) at a portion between the discharge portion (specifically, the downstream side portion of the check valve) of the fluid pump QA and the pressure adjusting valve UA. Therefore, the servo pressure Pu is introduced (supplied) to the servo chamber Ru. As the servo pressure Pu increases, the master pistons NM and NS are pressed in the forward direction Ha, and the hydraulic pressures Pmf and Pmr (front wheel and rear wheel supply pressure) in the front wheel and rear wheel master chambers Rmf and Rmr are increased.

Front wheel and rear wheel communication paths HSf and HSr (=HS) are connected to the front wheel and rear wheel master chambers Rmf and Rmr (=Rm). The front wheel and rear wheel communication paths HSf and HSr are connected to the front wheel and rear wheel cylinders CWf and CWr (=CW) via the lower braking unit SB (in particular, the lower actuator YB). Therefore, the front wheel and rear wheel supply pressures Pmf and Pmr are supplied from the upper braking unit SA to the front wheel and rear wheel cylinders CWf and CWr. Here, the front wheel supply pressure Pmf and the rear wheel supply pressure Pmr are equal (i.e., “Pmf=Pmr”).

### [Input Unit NR]

Although the braking operation member BP is operated by the input unit NR so as to realize the regenerative cooperative control, a state in which the wheel pressure Pw is not generated is generated. The “regenerative cooperative control” cooperates the friction braking force Fm (braking force by the wheel pressure Pw) and the regenerative braking force Fg (braking force by the motor/generator) so that kinetic energy of the vehicle JV can be efficiently recovered into electric energy by the motor/generator (not illustrated) at the time of braking. The input unit NR is configured by an input cylinder CN, an input piston NN, an introduction valve VA, an opening valve VB, a stroke simulator SS, and a simulator hydraulic pressure sensor PZ.

The input cylinder CN is fixed to the master cylinder CM. An input piston NN is inserted into the input cylinder CN. The input piston NN is mechanically connected to the braking operation member BP via a clevis (U-shaped link) so as to cooperatively operate with the braking operation member BP (brake pedal). The end face of the input piston NN and the end face of the primary piston NM have a gap Ks (also referred to as “separation displacement”). The regenerative cooperative control is realized by adjusting the separation distance Ks by the servo pressure Pu.

The input chamber Rn of the input unit NR is connected to the reaction force chamber Ro of the apply unit AP via an input path HN (fluid path). The input path HN is provided with a normally-closed introduction valve VA. The input path HN is connected to the master reservoir RV via the reservoir path HR between the introduction valve VA and the reaction force chamber Ro. The reservoir path HR is provided with a normally-open open valve VB. The introduction valve VA and the open valve VB are on/off type solenoid valves. A stroke simulator SS (also simply referred to as a “simulator”) is connected to the input path HN between the introduction valve VA and the reaction force chamber Ro.

When power supply (power supply) to the introduction valve VA and the open valve VB is not performed, the introduction valve VA is closed, and the open valve VB is opened. The input chamber Rn is sealed and fluidly locked by closing the introduction valve VA. As a result, the master pistons NM and NS are displaced integrally with the braking operation member BP. In addition, the simulator SS is communicated with the master reservoir RV by opening the open valve VB. When power supply (power supply) to the introduction valve VA and the open valve VB is performed, the introduction valve VA is opened, and the open valve VB is closed. As a result, the master pistons NM and NS can be displaced separately from the braking operation member BP. At this time, since the input chamber Rn is connected to the stroke simulator SS, the operation force Fp of the braking operation member BP is generated by the simulator SS. The input path HN is provided with a simulator pressure sensor PZ between the introduction valve VA and the reaction force chamber Ro so as to detect the hydraulic pressure Pz (simulator pressure) in the simulator SS. Note that since the simulator pressure Pz is also the internal pressure of the input chamber Rn, it is also a state quantity representing the operation force Fp of the braking operation member BP.

A state in which the master pistons NM and NS and the braking operation member BP are displaced separately (when solenoid valves VA, VB are energized) is referred to as a “first mode (or by-wire mode)”. In the first mode, the braking control device SC functions as a brake-by-wire type device (i.e., the device in which friction braking force Fm can be independently generated with respect to the braking operation of the driver). Therefore, in the first mode, the wheel pressure Pw is generated independently of the operation of the braking operation member BP. On the other hand, a state in which the master pistons NM and NS and the braking operation member BP are integrally displaced (when solenoid valves VA, VB are not energized) is referred to as a “second mode (or manual mode)”. In the second mode, the wheel pressure Pw is interlocked with the braking operation of the driver. In the input unit NR, one operation mode of the first mode (by-wire mode) and the second mode (manual mode) is selected depending on the presence or absence of power supply to the introduction valve VA and the open valve VB.

### <<Upper Controller EA>>

The upper controller EA controls the upper actuator YA. The upper controller EA is configured by a microprocessor MP and a drive circuit DR. The upper controller EA is connected to the communication bus BS so that a signal (detection value, calculation value, control flag, etc.) can be shared with other controllers (EB, ED, etc.).

The braking operation amount Ba is input to the upper controller EA. The braking operation amount Ba is a generic term for the state quantity representing the operation amount of the braking operation member BP. As the braking operation amount Ba, a detection signal Sp (operation displacement) of the operation displacement sensor SP and a detection signal Pz (simulator pressure) of the simulator pressure sensor PZ are directly input from the braking operation amount sensor BA to the upper controller EA. Furthermore, the supply pressure Pm, the required deceleration Gs, and the like are input to the upper controller EA via the communication bus BS. “Supply pressure Pm” is an output pressure of the upper actuator YA. The supply pressure Pm is detected by a supply pressure sensor PM provided in the lower actuator YB and transmitted from the lower controller EB. The required deceleration Gs is a required value of the automatic braking control, and is calculated by the driving assistance controller ED and transmitted from the driving assistance controller ED.

An algorithm of pressure adjusting control is programmed in the upper controller EA (in particular, the microprocessor MP). The “pressure adjusting control” is a control for adjusting the supply pressure Pm (eventually, the wheel pressure Pw). The pressure adjusting control is executed based on the braking operation amount Ba (operation displacement Sp, simulator pressure Pz), the required deceleration Gs, the supply pressure Pm, and the like Here, the braking operation amount Ba and the required deceleration Gs are collectively referred to as a “braking request amount Bs”. The braking request amount Bs is an input signal for instructing (requesting) the generation of the supply pressure Pm (as a result, the wheel pressure Pw to be generated by the braking control device SC).

The electric motor MA constituting the upper actuator YA and various solenoid valves (UA etc.) are driven by the drive circuit DR based on the algorithm of the pressure adjusting control. In the drive circuit DR, an H-bridge circuit is configured by switching elements (e.g., a MOS-FET) so as to drive the electric motor MA. In addition, the drive circuit DR includes a switching element so as to drive various solenoid valves (UA etc.). In addition, the drive circuit DR includes a motor current sensor (not illustrated) that detects a supply current Im (referred to as “motor current”) to the electric motor MA, and a pressure adjusting valve current sensor (not illustrated) that detects a supply current Ia (referred to as “pressure adjusting valve current”) to the pressure adjusting valve UA. Note that the electric motor MA is provided with a rotation angle sensor (not illustrated) that detects a rotation angle Ka (referred to as a “motor rotation angle”) of the rotor (rotor). Then, the motor rotation speed Na is calculated based on the motor rotation angle Ka.

In the upper controller EA, the target current It (target value) corresponding to the pressure adjusting valve current Ia (actual value) is calculated based on the braking request amount Bs (Ba, Gs, etc.) of the vehicle. In the control of the pressure adjusting valve UA, the pressure adjusting valve current Ia is controlled to approach and match the target current It. Furthermore, in the upper controller EA, the target rotation speed Nt (target value) corresponding to the motor rotation speed Na (actual value) is calculated based on the braking request amount Bs. In the control of the electric motor MA, the motor current Im is controlled such that the actual rotation speed Na approaches and matches the target rotation speed Nt. Specifically, if “Nt>Na”, the motor current Im is increased so that the motor rotation speed Na increases, and if “Nt<Na”, the motor current Im is decreased so that the motor rotation speed Na decreases. The drive signal Ma for controlling the electric motor MA and the drive signals Ua, Va, and Vb for controlling the various solenoid valves UA, VA, and VB are calculated based on these control algorithms. Then, the switching element of the drive circuit DR is driven according to the drive signal (Ma etc.), and the electric motor MA and the solenoid valves UA, VA, and VB are controlled.

### <Lower Braking Unit SB>

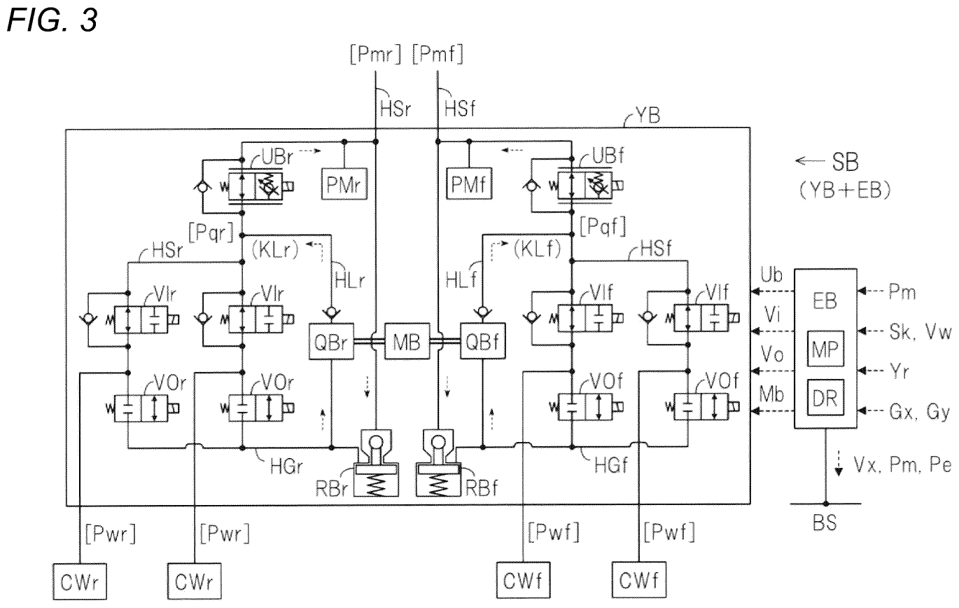

A configuration example of the lower braking unit SB of the braking control device SC will be described with reference to the schematic diagram of FIG. 3. The lower braking unit SB is a general-purpose unit (device) for executing anti-lock brake control, traction control, sideslip prevention control, and the like. In the traction control and the sideslip prevention control, the wheel pressure Pw of each wheel cylinder CW is automatically increased independently of the operation of the braking operation member BP.

The front wheel and rear wheel supply pressures Pmf and Pmr (=Pm) are supplied from the upper braking unit SA to the lower braking unit SB. Then, the front wheel and rear wheel supply pressures Pmf and Pmr are adjusted (increased or decreased) by the lower braking unit SB, and are eventually output as the hydraulic pressures Pwf and Pwr (front-wheel and rear-wheel wheel pressure) of the front wheel and rear wheel cylinders CWf and CWr. The lower braking unit SB includes a lower actuator YB and a lower controller EB.

### <<Lower Actuator YB>>

The lower actuator YB is provided between the upper actuator YA and the wheel cylinder CW in the communication path HS. The lower actuator YB is configured by a supply pressure sensor PM, a control valve UB, a lower fluid pump QB, a lower electric motor MB, a pressure adjusting reservoir RB, an inlet valve VI, and an outlet valve VO.

Front wheel and rear wheel control valves UBf and UBr (=UB) are provided on the front wheel and rear wheel communication paths HSf and HSr (=HS). Similarly to the pressure adjusting valve UA, the control valve UB is a normally open linear solenoid valve (differential pressure valve). The wheel pressure Pw can be individually increased in the front-rear wheel system from the supply pressure Pm by the control valve UB.

The front wheel and rear wheel supply pressure sensors PMf and PMr (=PM) are provided to detect the actual hydraulic pressures Pmf and Pmr (front wheel and rear wheel supply pressures) supplied from the upper actuator YA (in particular, front wheel and rear wheel master chambers Rmf, Rmr). The supply pressure sensor PM is also called a “master pressure sensor” and is built in the lower actuator YB. Signals of the front wheel and rear wheel supply pressures Pmf and Pmr (=Pm) are directly input to the lower controller EB and output to the communication bus BS. Note that since the front wheel supply pressure Pmf and the rear wheel supply pressure Pmr are substantially the same, any one of the front wheel and rear wheel supply pressure sensors PMf and PMr may be omitted. For example, in a configuration in which the rear wheel supply pressure sensor PMr is omitted, only the front wheel supply pressure Pmf is detected by the front wheel supply pressure sensor PMf.

Upper portions of the front wheel and rear wheel control valves UBf and UBr (a portion of the communication path HS on the side close to the upper actuator YA) and lower portions of the front wheel and rear wheel control valves UBf and UBr (a portion of the communication path HS on the side close to the wheel cylinder CW) are connected by the front wheel and rear wheel return paths HLf and HLr (=HL). The front wheel and rear wheel return paths HLf, HLr are provided with front wheel and rear wheel lower fluid pumps QBf, QBr (=QB) and front wheel and rear wheel pressure adjusting reservoirs RBf, RBr (=RB). The lower fluid pump QB is driven by the lower electric motor MB.

When the lower electric motor MB (also simply referred to as an “electric motor”) is driven, the braking fluid BF is sucked from the upper portion of the control valve UB and discharged to the lower portion of the control valve UB by the lower fluid pump QB (also simply referred to as a “fluid pump”). As a result, a circulation flow KL (i.e., the front wheel and rear wheel circulation flows KLf and KLr, indicated by broken line arrows) of the braking fluid BF including the fluid pump QB, the control valve UB, and the pressure adjusting reservoir RB is generated in the communication path HS and the return path HL. When the flow path of the communication path HS is narrowed by the control valve UB and the circulation flow KL (also referred to as “lower circulation flow”) of the braking fluid BF is throttled, the hydraulic pressure Pq (referred to as “adjustment pressure”) in the lower portion of the control valve UB is increased from the hydraulic pressure Pm (supply pressure) in the upper portion of the control valve UB by the orifice effect at that time. In other words, in the circulation flow KL, a hydraulic pressure difference (differential pressure) between the hydraulic pressure Pm (supply pressure) on the downstream side and the hydraulic pressure Pq (adjustment pressure) on the upstream side with respect to the control valve UB is adjusted by the control valve UB. Note that in the magnitude relationship between the supply pressure Pm and the adjustment pressure Pq, the adjustment pressure Pq is greater than or equal to the supply pressure Pm (i.e., “Pq≥Pm”). As described above, the mechanism of generating the adjustment pressure Pq in the lower actuator YB is the same as the mechanism of generating the servo pressure Pu in the upper actuator YA.

Inside the lower actuator YB, the front wheel and rear wheel communication paths HSf and HSr are branched into two and connected to the front wheel and rear wheel cylinders CWf and CWr, respectively. In order to individually adjust each wheel pressure Pw, a normally-open inlet valve VI and a normally-closed outlet valve VO are provided for each wheel cylinder CW. Specifically, the inlet valve VI is provided in the branched communication path HS (i.e., the side closer to the wheel cylinder CW with respect to the branched portion of the communication path HS.). The communication path HS is connected to the pressure adjusting reservoir RB via a pressure reducing path HG (fluid path) at a lower portion of the inlet valve VI (a portion of the communication path HS on a side close to the wheel cylinder CW). The outlet valve VO is disposed in the pressure reducing path HG. An on/off type solenoid valve is employed as the inlet valve VI and the outlet valve VO. The wheel pressure Pw can be individually reduced from the adjustment pressure Pq (or, the supply pressure Pm) at each wheel by the inlet valve VI and the outlet valve VO. Accordingly, anti-lock brake control, traction control, sideslip prevention control, and the like are executed.

When power is not supplied to the inlet valve VI and the outlet valve VO and their operations are stopped, the inlet valve VI is opened and the outlet valve VO is closed. In this state, the wheel pressure Pw is equal to the adjustment pressure Pq. The wheel pressure Pw is independently adjusted for each wheel cylinder CW by driving the inlet valve VI and the outlet valve VO. In order to reduce the wheel pressure Pw, the inlet valve VI is closed and the outlet valve VO is opened. Since the inflow of the braking fluid BF into the wheel cylinder CW is inhibited and the braking fluid BF in the wheel cylinder CW flows out to the pressure adjusting reservoir RB, the wheel pressure Pw is reduced. In order to increase the wheel pressure Pw, the inlet valve VI is opened and the outlet valve VO is closed. Since the outflow of the braking fluid BF to the pressure adjusting reservoir RB is inhibited and the adjustment pressure Pq from the pressure adjusting valve UB is supplied to the wheel cylinder CW, the wheel pressure Pw is increased. Here, the upper limit of the increase in the wheel pressure Pw is the adjustment pressure Pq. In order to maintain the wheel pressure Pw, both the inlet valve VI and the outlet valve VO are closed. Since the wheel cylinder CW is fluidly sealed, the wheel pressure Pw is maintained constant.

### <<Lower Controller EB>>

The lower controller EB controls the lower actuator YB. Similarly to the upper controller EA, the lower controller EB is configured by a microprocessor MP and a drive circuit DR. Since the lower controller EB is connected to the communication bus BS, the upper controller EA and the lower controller EB can share signals via the communication bus BS.

The wheel speed Vw, the steering operation amount Sk, the yaw rate Yr, the longitudinal acceleration Gx, and the lateral acceleration Gy are input to the lower controller EB (in particular, the microprocessor MP). The lower controller EB calculates the vehicle body speed Vx based on the wheel speed Vw. In the lower controller EB, the sideslip prevention control (ESC) is executed to appropriately maintain the steering characteristics of the vehicle JV (i.e., suppress understeering and oversteering) and improve the directional stability of the vehicle JV.

The lower controller EB drives the lower electric motor MB constituting the lower actuator YB and various solenoid valves (UB etc.). In the drive circuit DR of the lower controller EB, an H-bridge circuit is configured by switching elements (e.g., a MOS-FET) so as to drive the lower electric motor MB. In addition, the drive circuit DR includes a switching element so as to drive various solenoid valves (UB etc.). The drive signal Ub of the control valve UB, the drive signal Vi of the inlet valve VI, the drive signal Vo of the outlet valve VO, and the drive signal Mb of the lower electric motor MB are calculated based on a control algorithm programmed in the microprocessor MP. Then, the lower electric motor MB and the solenoid valves UB, VI, and VO are controlled by the drive circuit DR based on the drive signal (Ub, etc.).

### <Pressure Adjusting Control in Upper Braking Unit SA>

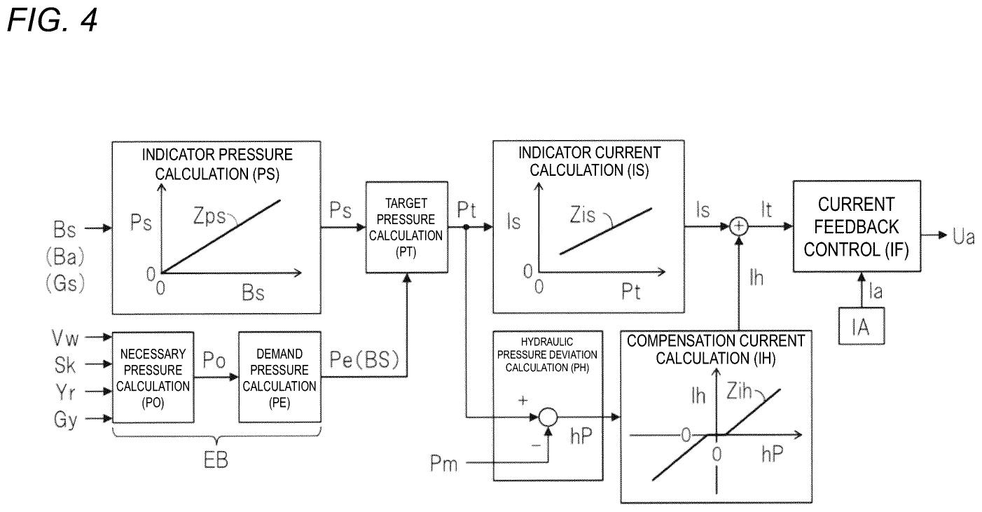

The pressure adjusting control in the upper braking unit SA will be described with reference to the block diagram of FIG. 4. In the pressure adjusting control, the supply pressure Pm (=Pw), which is the output pressure of the upper braking unit SA, is adjusted. Specifically, the target pressure Pt is determined, and the servo pressure Pu is adjusted by the pressure adjusting valve UA based on the target pressure Pt, so that the supply pressure Pm is ultimately adjusted.

The pressure adjusting control includes a necessary pressure calculation block PO, a demand pressure calculation block PE, an indicator pressure calculation block PS, a target pressure calculation block PT, an indicator current calculation block IS, a hydraulic pressure deviation calculation block PH, a compensation current calculation block IH, and a current feedback control block IF. For example, the processes of the necessary pressure calculation block PO and the demand pressure calculation block PE is executed by the lower controller EB, and the other processes (PS, PT, etc.) are executed by the upper controller EA.

In the necessary pressure calculation block PO, the necessary pressure Po corresponding to the wheel pressure Pw of each wheel cylinder CW is calculated based on the wheel speed Vw, the steering operation amount Sk, the yaw rate Yr, the lateral acceleration Gy, and the like. The “necessary pressure Po” is a target value for each wheel cylinder CW necessary for the execution of the sideslip prevention control. The “sideslip prevention control” is also called “vehicle behavior stabilization control”. In the sideslip prevention control, an unstable behavior (i.e., oversteer and understeer) of the vehicle JV is stabilized by applying a braking force (ultimately, application of yaw moment) to each wheel WH.

In the necessary pressure calculation block PO, the extent (degree) of stability of the vehicle JV is calculated based on the vehicle body speed Vx, the steering operation amount Sk, the yaw rate Yr, and the lateral acceleration Gy. Specifically, in the necessary pressure calculation block PO, the following calculation is performed. First, the vehicle body speed Vx is calculated based on the wheel speed Vw. Then, the target behavior (e.g., the target yaw rate and the target slip angle) is calculated based on the vehicle body speed Vx and the steering operation amount Sk. In addition, the actual behavior (e.g., the actual yaw rate and the actual slip angle) corresponding to the target behavior is calculated based on the yaw rate Yr, the lateral acceleration Gy, and the like. The steering characteristic (degree of understeer/oversteer) of the vehicle JV is identified based on the comparison result (e.g., a difference between the target behavior and the actual behavior) between the target behavior and the actual behavior. The necessary pressure Po corresponding to each wheel pressure Pw is determined so that the steering characteristics are optimized (i.e., the vehicle behavior is stabilized). In the sideslip prevention control, for example, four necessary pressures Po are calculated. Then, each wheel pressure Pw is controlled to approach and match each necessary pressure Po. As a result, the yaw moment is applied to the vehicle JV, the understeer and the oversteer are suppressed, and the yawing behavior of the vehicle JV is stabilized.

In the demand pressure calculation block PE, the demand pressure Pe is calculated based on the necessary pressure Po. The “demand pressure Pe” is a target value required for executing the sideslip prevention control. Specifically, the maximum pressure among the plurality of necessary pressures Po is determined as the demand pressure Pe (i.e., “Pe=MAX (Po)”). Alternatively, the demand pressure Pe may be determined by adding the predetermined pressure pe to the maximum value of the plurality of necessary pressures Po (i.e., “Pe=MAX (Po)+pe”). Here, the “predetermined pressure pe” is a predetermined value (constant) set in advance. In any case, the demand pressure Pe is determined based on the maximum value of the necessary pressure Po. The demand pressure Pe is transmitted from the lower controller EB to the communication bus BS and received by the upper controller EA.

In the indicator pressure calculation block PS, the indicator pressure Ps is calculated based on the braking request amount Bs. The “braking request amount Bs” is a generic term for the braking operation amount Ba and the required deceleration Gs, and is an input for instructing generation (i.e., the wheel pressure Pw to be generated by the braking control device SC) of the supply pressure Pm. The braking request amount Bs is calculated based on the braking operation amount Ba and the required deceleration Gs. For example, the braking operation amount Ba and the required deceleration Gs are compared in the dimension of the vehicle deceleration, and the larger one of them is determined as the braking request amount Bs. The “indicator pressure Ps” is a target value corresponding to the supply pressure Pm, and is an intermediate target value for calculating the target pressure Pt which is a final target value. The indicator pressure Ps is calculated so as to increase according to the calculation map Zps set in advance as the braking request amount Bs increases.

In the target pressure calculation block PT, the target pressure Pt is calculated based on the indicator pressure Ps and the demand pressure Pe. The “target pressure Pt” is a final target value corresponding to the supply pressure Pm (as a result, the wheel pressure Pw). Specifically, the larger one of the indicator pressure Ps and the demand pressure Pe is determined as the target pressure Pt (i.e., “Pt=MAX(Ps, Pe)”). Therefore, if “Ps>Pe” and the indicator pressure Ps is adopted as the target pressure Pt, the target pressure Pt is a target value corresponding to the wheel pressure Pw to be achieved according to the braking request amount Bs. If “Ps<Pe” and the demand pressure Pe is adopted as the target pressure Pt, the target pressure Pt is a target value corresponding to the wheel pressure Pw required for the sideslip prevention control.

In the indicator current calculation block IS, the indicator current Is is calculated based on the target pressure Pt and the calculation map Zis set in advance. The “indicator current Is” is a target value corresponding to the supply current Ia of the pressure adjusting valve UA necessary for achieving the target pressure Pt. The indicator current Is is determined to increase according to the calculation map Zis as the target pressure Pt increases. The indicator current calculation block IS corresponds to feedforward control based on the target pressure Pt.

In the hydraulic pressure deviation calculation block PH, a deviation hP (referred to as a “hydraulic pressure deviation”) between the target pressure Pt and the supply pressure Pm is calculated. Specifically, the supply pressure Pm is subtracted from the target pressure Pt to determine the hydraulic pressure deviation hp (i.e., “hP=Pt−Pm”).

In the compensation current calculation block IH, the compensation current Ih is calculated based on the hydraulic pressure deviation hP and the preset calculation map Zih. The indicator current Is is calculated in accordance with the target pressure Pt, but an error may occur between the target pressure Pt and the supply pressure Pm. The “compensation current Ih” is for compensating (reducing) this error. The compensation current Ih is determined to increase as the hydraulic pressure deviation hP increases according to the calculation map Zih. Specifically, when the target pressure Pt is larger than the supply pressure Pm and the hydraulic pressure deviation hP has a positive sign, the compensation current Ih of the positive sign is determined so that the indicator current Is is increased. On the other hand, when the target pressure Pt is smaller than the supply pressure Pm and the hydraulic pressure deviation hP has a negative sign, the compensation current Ih of the negative sign is determined so that the indicator current Is is decreased. Here, a dead zone is provided in the calculation map Zih. Furthermore, the compensation current calculation block IH corresponds to feedback control based on the supply pressure Pm.

The compensation current Ih is added to the indicator current Is, and the target current It is calculated (i.e., “It=Is+Ih”). The “target current It” is a final target value of the current supplied to the pressure adjusting valve UA. That is, the target current It is determined as the sum of the indicator current Is, which is the feedforward term, and the compensation current Ih, which is the feedback term. Therefore, the drive control of the pressure adjusting valve UA is configured by feedforward control (process of the indicator current calculation block IS) and feedback control (process of the compensation current calculation block IH) in the hydraulic pressure.

In the current feedback control block IF, the drive signal Ua is calculated based on the target current It (target value) and the supply current Ia (actual value) such that the supply current Ia approaches and matches the target current It. Here, the supply current Ia is detected by a pressure adjusting valve current sensor IA provided in the drive circuit DR. In the current feedback control block IF, if “It>Ia”, the drive signal Ua is determined such that the supply current Ia increases. On the other hand, if “It<Ia”, the drive signal Ua is determined such that the supply current Ia decreases. That is, in the current feedback control block IF, feedback control related to the current is executed. Therefore, the drive control of the pressure adjusting valve UA includes feedback control related to the current in addition to feedback control related to the hydraulic pressure.

The braking control device SC includes two braking units SA and SB. One is the upper braking unit SA. The upper braking unit SA electrically outputs the supply pressure Pm according to the braking request amount Bs (e.g., the braking operation amount Ba and the required deceleration Gs). Specifically, the upper braking unit SA can output the supply pressure Pm independently of the operation of the braking operation member BP by the driver using the electric motor MA as a power source. The other is the lower braking unit SB. The lower braking unit SB is provided between the upper braking unit SA and the plurality of wheel cylinders CW. The lower braking unit SB can individually adjust (increase, decrease) the supply pressure Pm with respect to each of the plurality of wheel cylinders CW and output the wheel pressure Pw. Specifically, the lower braking unit SB includes an electric motor MB, a fluid pump QB, and a plurality of solenoid valves (VI, VO, etc.). In the lower braking unit SB, the wheel pressure Pw can be adjusted for each wheel cylinder CW by controlling the electric motor MB and the plurality of solenoid valves.

In the braking control device SC, when the lower braking unit SB executes the sideslip prevention control, the upper braking unit SA increases the supply pressure Pm to the demand pressure Pe necessary for executing the sideslip prevention control. That is, the demand pressure Pe necessary for executing the sideslip prevention control is supplied as the supply pressure Pm from the upper braking unit SA to the lower braking unit SB. Specifically, when the demand pressure Pe required to execute the sideslip prevention control is larger than the indicator pressure Ps calculated from the braking operation amount Ba, the deviation hP between the supply pressure Pm and the demand pressure Pe is calculated based on the demand pressure Pe (=Pt), and the supply pressure Pm is electrically controlled so that the deviation hp becomes “0”. As a typical example, when the braking operation member BP is not operated and the automatic braking control is not executed (i.e., when the braking request amount Bs is “0”), the supply pressure Pm is controlled to approach and match the demand pressure Pe. Note that the indicator pressure Ps is determined so as to increase as the braking operation amount Ba increases.

The demand pressure Pe is determined based on the necessary pressure Po corresponding to each wheel pressure Pw. Specifically, in the sideslip prevention control, the necessary pressure Po (target value) required for each wheel cylinder CW is calculated based on the yaw rate Yr and the like so as to suppress the unstable behavior (i.e., oversteer/understeer) of the vehicle JV. The demand pressure Pe is calculated based on the maximum value (Max[Po]) of the plurality of necessary pressures Po. For example, the maximum value itself of the necessary pressure Po is determined as the demand pressure Pe. Alternatively, a predetermined pressure pe set in advance may be added to the maximum value of the necessary pressure Po to be determined as the demand pressure Pe. In any case, the demand pressure Pe is calculated based on the maximum value of the necessary pressure Po.

The lower braking unit SB includes a control valve UB that increases the supply pressure Pm by throttling the lower circulation flow KL discharged by the lower fluid pump QB driven by the lower electric motor MB. However, when the demand pressure Pe is realized by the supply pressure Pm from the upper braking unit SA, it is unnecessary to increase the supply pressure Pm in the lower braking unit SB. In such a case, power is not supplied to the control valve UB, and the control valve UB is maintained in the fully opened state. Note that the electric motor MB is driven at the time of execution of the sideslip prevention control so as to discharge the braking fluid BF in the pressure adjusting reservoir RB.

In the sideslip prevention control, the braking force of each wheel WH is individually generated by individual control of each wheel pressure Pw. Accordingly, the directional stability is improved by the application of the yaw moment to the vehicle and furthermore the deceleration of the vehicle. The magnitude of the yaw moment and the braking force necessary for stabilizing the vehicle depends on vehicle specifications (vehicle weight, yaw inertia moment, height of gravitational center, etc.) of the vehicle. Specifically, a larger yaw moment (e.g., the right/left difference of the braking force) is necessary for a vehicle having a larger yaw inertia moment (an amount representing a degree of inertia with respect to rotational motion in the yawing direction). In addition, a larger braking force is necessary for a vehicle having a larger weight and/or a larger height of gravitational center. Therefore, for vehicles having larger vehicle weight, yaw inertia moment, height of gravitational center, and the like, the demand pressure Pe is larger, and the responsiveness thereof is necessary. Therefore, in the device in which the wheel pressure necessary for the sideslip prevention control is generated in the lower braking unit, the rated output of the lower braking unit needs to be set based on vehicle specifications (yaw inertia moment, vehicle weight, center of gravity position, etc.) for each vehicle type.

In the braking control device SC, the demand pressure Pe necessary for the sideslip prevention control is generated by the upper braking unit SA. The upper braking unit SA also corresponds to a sudden operation of the braking operation member BP. In the upper braking unit SA, since the high wheel pressure Pw can be generated with high response, the rated output of the upper braking unit SA can be sufficiently satisfied even for the sideslip prevention control. In the braking control device SC, since the demand pressure Pe is supplied as the supply pressure Pm from the upper braking unit SA, in the lower braking unit SB, it is merely necessary to individually adjust the supply pressure Pm based on each necessary pressure Po, and it is not necessary to further increase the differential pressure between the supply pressure Pm and the wheel pressure Pw. That is, the adjustment of the wheel pressure Pw in the lower braking unit SB is sufficient by maintaining the hydraulic pressure, reducing the pressure from the supply pressure Pm, and increasing the pressure to the supply pressure Pm.

In the braking control device SC, in the sideslip prevention control, a large amount of output (high response and high pressure output) is not required for the lower braking unit SB. Therefore, the rating (output of lower electric motor MB, discharge amount of lower fluid pump QB, etc.) of the lower braking unit SB can be set regardless of vehicle specifications. Therefore, in the braking control device SC, the common lower braking unit SB is also applicable to a vehicle (i.e., a large-sized vehicle) having a large vehicle weight, yaw inertia moment, etc. That is, in various vehicles, the lower braking unit SB that executes the sideslip prevention control is made common. The pressurizing function of the lower braking unit SB is used for complementary control to be described next.

### <Complementary Control in Lower Braking Unit SB>

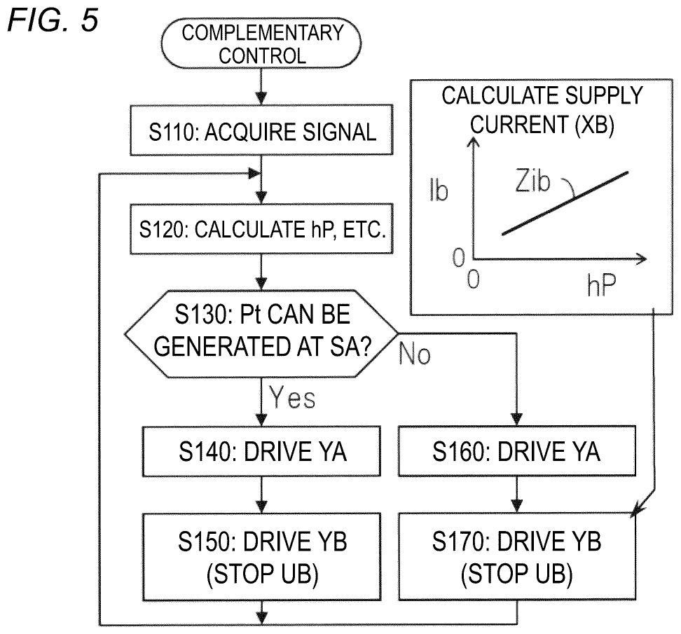

The complementary control in the lower braking unit SB will be described with reference to the flowchart of FIG. 5. In the braking control device SC, in the sideslip prevention control, the wheel pressure Pw can be increased not only by the upper braking unit SA but also by the lower braking unit SB. The “complementary control” is a control in which the shortage is compensated by the lower braking unit SB when the sufficient supply pressure Pm cannot be generated by the upper braking unit SA (i.e., when a decrease in output occurs in the upper braking unit SA and the target pressure Pt cannot be achieved) upon executing the sideslip prevention control. The process of the complementary control is executed by the upper and lower braking units SA and SB (in particular, the upper and lower controllers EA, EB). Note that in the following description, it is assumed that the indicator pressure Ps is smaller than the demand pressure Pe and the demand pressure Pe is calculated as the target pressure Pt (i.e., in the case of “Pt=Pe”).

In step S110, various signals are read by the upper and lower controllers EA and EB. Specifically, the supply pressure Pm, the demand pressure Pe, the power supply voltage Vm, the motor temperature Tm, and the like are acquired. The supply pressure Pm is detected by the supply pressure sensor PM and acquired by the lower controller EB. Furthermore, the supply pressure Pm is acquired by the upper controller EA via the communication bus BS. The demand pressure Pe is calculated by the lower controller EB and acquired by the upper controller EA via the communication bus BS. The power supply voltage Vm is a supply voltage to the upper electric motor MA, is detected by a voltage sensor (not illustrated) provided in the drive circuit DR of the upper controller EA, and is acquired by the upper controller EA. The motor temperature Tm is a temperature related to the upper electric motor MA. Specifically, the motor temperature Tm corresponds to the temperature of the electric motor MA itself, the temperature of the drive circuit DR that drives the electric motor MA, and the like. The motor temperature Tm is detected by a temperature sensor (not illustrated) provided in the electric motor MA and a temperature sensor (not illustrated) provided in the drive circuit DR, and is acquired by the upper controller EA. The power supply voltage Vm and the motor temperature Tm are acquired by the lower controller EB via the communication bus BS.

In step S120, various state quantities such as the hydraulic pressure deviation hP are calculated by the upper and lower controllers EA and EB. The hydraulic pressure deviation hP is a state quantity representing a shortage of the supply pressure Pm with respect to the target pressure Pt. The hydraulic pressure deviation hP is determined by subtracting the supply pressure Pm from the target pressure Pt (i.e., hP=Pt−Pm), similarly to the process of the hydraulic pressure deviation calculation block PH described above. Since “Pt=Pe”, “hP=Pe−Pm”.

In step S130, “Whether or not the target pressure Pt can be generated in the upper braking unit SA” is determined. This determination is called “availability determination”. The availability determination is performed based on at least one of the hydraulic pressure deviation hp, the power supply voltage Vm, and the motor temperature Tm. Specifically, the determination is made based on at least one of the following methods.

(1) The availability determination is performed on “whether or not the hydraulic pressure deviation hP is less than the predetermined pressure hp”. The predetermined pressure hp is a predetermined value (constant) set in advance. If “hP<hp”, it is determined that “generation of the target pressure Pt is possible (referred to as “possible state”)”, and the availability determination is affirmed. On the other hand, if “hp≥hp”, it is determined that “generation of the target pressure Pt is impossible (referred to as “impossible state”)”, and the availability determination is denied.

(2) The availability determination is performed on “whether or not the power supply voltage Vm is greater than or equal to a predetermined voltage vm”. The predetermined voltage vm is a predetermined value (constant) set in advance. If “Vm≥vm, the possible state is determined, and if “Vm<vm”, the impossible state is determined. This is based on the fact that the output of the electric motor MA decreases when the power supply voltage Vm is low.

(3) The availability determination is performed on “Whether or not motor temperature Tm is lower than predetermined temperature td”. The predetermined temperature tm is a predetermined value (constant) set in advance. If “Tm<tm”, the possible state is determined, and if “Tm≥tm”, the impossible state is determined. This is based on the fact that the output of the electric motor MA decreases when the motor temperature Tm is high.

When the availability determination is affirmed, the normal control is executed in steps S140 and S150. Here, the “normal control” is the pressure adjusting control described with reference to FIG. 4, and realizes the target pressure Pt (=Pe) only by the upper braking unit SA. Therefore, in the lower braking unit SB, the lower electric motor MB, the inlet valve VI, and the outlet valve VO are energized and driven, but the control valve UB is not energized and the drive thereof is stopped.

In step S140, the upper actuator YA is driven by the upper controller EA. Specifically, the upper electric motor MA is driven to generate the upper circulation flow KN in the reflux path HK. Then, the pressure adjusting valve UA is driven based on the method described above, and the supply pressure Pm is controlled so as to approach and match the target pressure Pt (=Pe).

In step S150, the lower actuator YB is driven by the lower controller EB. Specifically, the lower electric motor MB is driven, and the braking fluid BF flowing into the pressure adjusting reservoir RB is returned to the upper portion of the inlet valve VI by the lower fluid pump QB. This is based on the fact that the decrease in the wheel pressure Pw of the sideslip prevention control is realized by the braking fluid BF being moved from the wheel cylinder CW to the pressure adjusting reservoir RB, but the volume of the pressure adjusting reservoir RB is finite. The braking fluid BF is pumped out from the pressure adjusting reservoir RB by the fluid pump QB so that the wheel pressure Pw can be continuously decreased.

Furthermore, in step S150, in the sideslip prevention control, each wheel pressure Pw is individually adjusted in order to control the yaw moment acting on the vehicle body. The individual adjustment of the wheel pressure Pw is performed by driving the inlet valve VI and the outlet valve VO with the supply pressure Pm as the original pressure, as described above. Therefore, the adjustable range of the wheel pressure Pw is less than or equal to the supply pressure Pm. Note that in the normal control, since the original pressure Pe (demand pressure) of the sideslip prevention control is supplied by the upper braking unit SA, the power supply to the control valve UB is stopped and the control valve UB is not driven. Since the electric motor MB is driven, the circulation flow KL is generated by the fluid pump QB. However, since the control valve UB is in the fully opened state, the hydraulic pressure Pq (adjustment pressure) at the lower portion of the control valve UB (upstream side with respect to the fluid pump QB) remains at the pressure Pm (supply pressure) at the upper portion of the control valve UB (downstream side with respect to the fluid pump QB) (i.e., “Pm=Pq”).

When the availability determination is denied, the complementary control is executed in steps S160 and S170. The complementary control is a control in which, when the supply pressure Pm is insufficient with respect to the target pressure Pt (i.e., the demand pressure Pe), the shortage is compensated by the lower braking unit SB. In step S160, as in step S140, the upper actuator YA is driven by the upper controller EA. In step S170, the lower actuator YB is driven by the lower controller EB based on the hydraulic pressure deviation hP. Since the hydraulic pressure deviation hP is a difference between the target pressure Pt (target value) and the supply pressure Pm (actual value), it is a state quantity representing a shortage of the supply pressure Pm with respect to the demand pressure Pe. Therefore, in the lower braking unit SB, the supply current Ib to the control valve UB is controlled based on the hydraulic pressure deviation hP. During the execution of the sideslip prevention control, the electric motor MB is driven, and the lower circulation flow KL is generated by the fluid pump QB. Therefore, when the valve opening amount of the control valve UB is reduced by the supply current Ib, the flow path of the communication path HS is narrowed, so that a differential pressure is generated. As a result, the adjustment pressure Pq is increased from the supply pressure Pm.

As illustrated in the supply current calculation block XB, the supply current Ib (referred to as “control valve current”) to the control valve UB is calculated based on the hydraulic pressure deviation hP (target value of the differential pressure by the control valve UB) (see the blowout portion). Specifically, the supply current Ib is controlled to increase as the hydraulic pressure deviation hp increases based on the calculation map Zib set in advance. Therefore, the adjustment pressure Pq is increased by the hydraulic pressure deviation hP from the supply pressure Pm by the power supply to the control valve UB. That is, when the upper braking unit SA cannot achieve the supply pressure Pe, the shortage is compensated by the lower braking unit SB. Note that in the complementary control as well, the individual control of each wheel pressure Pw is performed by the inlet valve VI and the outlet valve VO provided at the lower portion of the control valve UB.

When the demand pressure Pe is realized by the upper braking unit SA (i.e., when the supply pressure Pm reaches the demand pressure Pe), power is not supplied to the control valve UB in the lower braking unit SB, and the fully opened state is maintained. On the other hand, when the supply pressure Pm is insufficient with respect to the demand pressure Pe, power is supplied to the control valve UB, and the circulation flow KL is throttled, so that the shortage (i.e., the hydraulic pressure “Pe−Pm”) of the supply pressure Pm with respect to the demand pressure Pe is compensated by the lower braking unit SB. By this complementary control, even when the output of the upper braking unit SA (in particular, the upper electric motor MA and the pressure adjusting valve UA) decreases and the demand pressure Pe cannot be achieved in the upper braking unit SA, the demand pressure Pe is achieved. As a result, the performance of the sideslip prevention control is secured, and the stability of the vehicle JV is reliably maintained.

### Other Embodiments

Other embodiments will be described below. In other embodiments as well, the effects similar to the above (commonization of the lower braking unit SB, etc.) are achieved.

In the above-described embodiment, the demand pressure Pe is calculated by the lower braking unit SB and transmitted to the upper braking unit SA. Alternatively, the demand pressure Pe may be calculated by the upper braking unit SA. Since signals such as the wheel speed Vw and the yaw rate Yr are input to the lower braking unit SB, the determination on the start/end of the sideslip prevention control and the calculation of each necessary pressure Po corresponding to each wheel pressure Pw are performed by the lower braking unit SB. However, in the upper and lower braking units SA and SB, since the signal is shared in the communication bus BS, the demand pressure Pe can be calculated by the upper braking unit SA. Therefore, the demand pressure Pe is calculated by either one of the upper and lower braking units SA and SB based on the necessary pressure Po.

In the above-described embodiment, the front-rear type is adopted as the two-system braking system. Alternatively, a diagonal type (also referred to as “X type”) may be adopted as the two-system braking system. In this configuration, one of the two master chambers Rm is connected to the left front wheel cylinder and the right rear wheel cylinder, and the other of the two master chambers Rm is connected to the right front wheel cylinder and the left rear wheel cylinder.

In the above-described embodiment, the tandem type is exemplified as the master cylinder CM. Instead, a single type master cylinder CM may be adopted. In this configuration, the secondary master piston NS is omitted. Then, one master chamber Rm is connected to the four wheel cylinders CW. In this configuration, the same supply pressures Pmf and Pmr (=Pm) are output from the master cylinder CM.

In the configuration in which the single-type master cylinder CM is adopted, the master chamber Rm may be connected to the front wheel cylinder CWf, and the pressure adjustment unit CA may be directly connected to the rear wheel cylinder CWr. In this configuration, the front wheel supply pressure Pmf is output from the master cylinder CM to the front wheel cylinder CWf as the front-wheel wheel pressure Pwf. On the other hand, the servo pressure Pu is output from the pressure adjustment unit CA to the rear wheel cylinder CWr as the rear wheel supply pressure Pmr.

In the above-described embodiment, in the apply unit AP, the pressure receiving area rm (master area) of the master chamber Rm and the pressure receiving area ru (servo area) of the servo chamber Ru are set equal. The master area rm and the servo area ru may not be equal. In the configuration in which the master area rm and the servo area ru are different, the conversion calculation of the supply pressure Pm and the servo pressure Pu is possible based on the ratio of the servo area ru and the master area rm (i.e., conversion based on “Pm·rm=Pu·ru”).

### Summary of Embodiments

Hereinafter, embodiments of the braking control device SC will be summarized. The braking control device SC includes “an upper braking unit SA that electrically outputs the supply pressure Pm according to the braking request amount Bs” and “a lower braking unit SB disposed between the upper braking unit SA and the plurality of wheel cylinders CW and configured to individually adjust the supply pressure Pm with respect to each of the plurality of wheel cylinders CW and output the wheel pressure Pw”. In the lower braking unit SB, the supply pressure Pm is individually increased and decreased for each wheel cylinder CW, and the wheel pressure Pw can be individually adjusted.

When the sideslip prevention control is executed in the lower braking unit SB, the demand pressure Pe necessary for executing the sideslip prevention control is supplied from the upper braking unit SA. That is, the supply pressure Pm output from the upper braking unit SA is increased until reaching the demand pressure Pe. For example, when the braking request amount Bs is “0” and the sideslip prevention control is not executed, the operations of both the upper and lower braking units SA, SB are stopped, and the wheel pressure Pw is not generated. In this state, when the sideslip prevention control is executed in the lower braking unit SB, not only is the lower braking unit SB is operated, but the upper braking unit SA is also operated to supply the demand pressure Pe. Here, the sideslip prevention control is a control for controlling the yaw moment acting on the vehicle JV by automatically and individually adjusting (i.e., increasing and decreasing) the wheel pressure Pw, suppressing oversteer and understeer, and optimizing steering characteristics.

The demand pressure Pe is determined based on the maximum value Max [Po] of the necessary pressures Po required for each of the plurality of wheel cylinders CW. For example, in the lower braking unit SB, the necessary pressure Po required for each of the plurality of wheel cylinders CW is calculated based on the wheel speed Vw, the steering operation amount Sk, the yaw rate Yr, the lateral acceleration Gy, and the like. The demand pressure Pe is determined based on the maximum value of the plurality of necessary pressures Po.

In the braking control device SC, the pressure (i.e., the demand pressure Pe) which is the basis of the sideslip prevention control is generated in the upper braking unit SA. Since the rated output of the upper braking unit SA corresponds to sudden braking (braking that generates a rapid and high wheel pressure), it is sufficient for the sideslip prevention control. Since the demand pressure Pe is supplied by the upper braking unit SA, even if the weight, inertia moment, and the like of the vehicle are large, the lower braking unit SB (in particular, the output of the lower electric motor MB and the discharge amount of the lower fluid pump QB) is not required to have such a rated output. That is, the rating of the lower braking unit SB can be set without depending on vehicle specifications (weight, inertia moment, height of gravitational center, etc.). Therefore, the lower braking unit SB that executes the sideslip prevention control is made common.

In the braking control device SC, when the upper braking unit SA cannot increase the supply pressure Pm to the demand pressure Pe, the lower braking unit SB executes the complementary control. In the complementary control, the wheel pressure Pw is increased by a deviation hp (hydraulic pressure deviation) between the supply pressure Pm and the demand pressure Pe. For example, the lower braking unit SB includes the electric motor MB, the fluid pump QB, and the control valve UB that increases the supply pressure Pm by throttling the circulation flow KL discharged from the fluid pump QB. In the complementary control, power is supplied to the electric motor MB, and the circulation flow KL of the braking fluid BF is discharged from the fluid pump QB. Then, the supply current Ib determined based on the hydraulic pressure deviation hP is supplied to the control valve UB. As a result, the wheel pressure Pw is increased from the supply pressure Pm by the hydraulic pressure deviation hP. That is, when the upper braking unit SA cannot supply the supply pressure Pm corresponding to the demand pressure Pe, the hydraulic pressure deviation hP, which is the shortage, is increased in the lower braking unit SB. Since the demand pressure Pe is reliably achieved by the complementary control, the performance of the sideslip prevention control is secured even if the output of the upper braking unit SA decreases. Note that when the upper braking unit SA can increase the supply pressure Pm to the demand pressure Pe, power is not supplied to the control valve UB, but power is supplied to the electric motor MB. This is because the braking fluid BF flowing into the pressure adjusting reservoir RB is discharged from the pressure adjusting reservoir RB in order to reliably reduce the wheel pressure Pw.

1. A braking control device for a vehicle comprising:
an upper braking unit that electrically outputs a supply pressure according to a braking request amount; and
a lower braking unit that is disposed between the upper braking unit and a plurality of wheel cylinders, individually adjusts the supply pressure with respect to each of the plurality of wheel cylinders, and outputs a wheel pressure; wherein
the upper braking unit increases the supply pressure to a demand pressure necessary for executing a sideslip prevention control when the lower braking unit executes the sideslip prevention control.

2. The braking control device for the vehicle according to claim 1, wherein
the demand pressure is determined based on a maximum value of necessary pressures required for each of the plurality of wheel cylinders.

3. The braking control device for the vehicle according to claim 2, wherein
when the upper braking unit cannot increase the supply pressure to the demand pressure,
the lower braking unit increases the wheel pressure by a deviation between the supply pressure and the demand pressure.

4. The braking control device for the vehicle according to claim 1, wherein
when the upper braking unit cannot increase the supply pressure to the demand pressure,
the lower braking unit increases the wheel pressure by a deviation between the supply pressure and the demand pressure.
